(19) United States
(12) Patent Application Publication
(10) Pub. No.: US 2025/0121535 A1
(43) Pub. Date: Apr. 17, 2025

(54) MOLDED ARTICLE, METHOD FOR MANUFACTURING SAME, METHOD FOR MANUFACTURING FIBER-REINFORCED PLASTIC PRODUCT, AND METHOD FOR IMPROVING ANTIBACTERIAL OR ANTIVIRAL PROPERTIES

(71) Applicants: TOYUGIKEN CO.,LTD., Minami-Ashigara-shi, Kanagawa (JP); MEIJI UNIVERSITY, Tokyo (JP)

(72) Inventors: Mamoru AIZAWA, Kawasaki-shi, Kanagawa (JP); Kitaru SUZUKI, Kawasaki-shi, Kanagawa (JP); Ayano KATO, Kawasaki-shi, Kanagawa (JP); Tetsuo KIKUCHI, Minami-Ashigara-shi, Kanagawa (JP)

(21) Appl. No.: 18/715,604

(22) PCT Filed: Jul. 12, 2022
(86) PCT No.: PCT/JP2022/027412

§ 371 Date: Dec. 17, 2024

(30) Foreign Application Priority Data
Dec. 1, 2021 (JP) 2021-195310

(51) Int. Cl. B29C 37/00; B29C 70/06; B29K 105/00; B29K 505/10; B29K 505/14

(52) U.S. Cl. CPC B29C 37/0028; B29C 70/06; B29C 2037/0035; B29K 2105/0011; B29K 2505/10; B29K 2505/14

(57) ABSTRACT

The purpose of the present invention is to provide a novel molded article having antibacterial or antiviral properties, a method for manufacturing the same, and the like. The present invention relates to a molded article 100 which contains a calcium compound 104 and a resin, and has a salt of inositol phosphate 102 with at least one metal element 103 selected from the group consisting of silver, zinc, and copper on a surface 101.

### TECHNICAL FIELD

The present invention relates to a molded article, a method for manufacturing the same, a method for manufacturing a fiber-reinforced plastic product, a method for improving antibacterial or antiviral properties, and the like.

### BACKGROUND ART

In recent years, along with increasing hygiene consciousness, plastic products with antibacterial properties have been developed. For example, a method has been proposed in which a resin is kneaded with a material that exhibits antibacterial properties (hereinafter, referred to as an “antibacterial material”) to cause a plastic product to exhibit antibacterial properties.

For example, Non-Patent Document 1 discloses that zeolite filled with silver ions has antibacterial properties and antibacterial properties can be imparted to a plastic product by adding the silver zeolite to a resin.

Patent Document 1 discloses an antibacterial material in which antibacterial metal particles such as silver fine particles and the like are partially exposed and embedded in at least a part of a surface of a base material of a plastic product and the like in a dispersed manner. According to Patent Document 1, such an antibacterial material can be manufactured at low cost by a simple treatment and has durable antibacterial properties.

Patent Document 2 discloses a resin bathtub manufactured by adding and mixing an antibacterial agent to a resin material in advance, then adding and mixing a filler thereto, and then molding the mixed material. According to Patent Document 2, in such a resin bathtub, the antibacterial agent is evenly and sufficiently dispersed in the resin material without being hindered by the filler, and thus, sufficient antibacterial capability can be imparted to the resin bathtub even with a small amount of the antibacterial agent added.

Patent Document 3 discloses an antibacterial member in which an antibacterial material is attached to a surface of a base material and a resin coating film is formed on the surface to which the antibacterial material is attached to an extent that antibacterial properties remain. According to Patent Document 3, in such an antibacterial member, an antibacterial material is not peeled off due to the action of friction, mechanical stress, and the like, the antibacterial member has excellent chemical resistance to a cleaner, and the like, and excellent antibacterial properties can be maintained for a long period of time.

By the way, a fiber-reinforced plastic (also referred to as FRP) is known as a plastic material that is lightweight and is less likely to rust and to corrode while having high strength. The fiber-reinforced plastic is a composite material containing a fiber material such as a glass fiber, a carbon fiber, or the like, and a resin material (plastic), and the demand in the market is increasing. For example, the fiber-reinforced plastic is used not only as a member for vehicles and aircrafts, but also as a part of daily necessities.

### CITATION LIST

### Patent Documents

Patent Document 1: Japanese Patent Application Laid-Open No. 2000-319109
Patent Document 2: Japanese Patent Application Laid-Open No. H11-58555
Patent Document 3: Japanese Patent Application Laid-Open No. 2009-40729

### Non-Patent Document

Non-Patent Document 1: Kiyotaka Kudo et al., Inorganic materials, no. 283, pp. 492-496, 1999

### SUMMARY OF INVENTION

### Technical Problem

However, when the present inventors have conducted an intensive investigation on a conventional plastic product with antibacterial properties, it has been found that the antibacterial properties are not sufficient. For example, in a plastic product in which the antibacterial properties are exhibited by kneading the above-described antibacterial material with a resin, the antibacterial material tends to be easily peeled off or eluted, and thus the duration of the antibacterial properties is extremely short. In addition, when such a plastic product loses the antibacterial properties once, it is difficult to impart the antibacterial properties again, and there is also a problem that the life cycle of the product is short. Further, there have been few reports on imparting antibacterial properties to fiber-reinforced plastic products. In addition, in recent years, there has been an increasing demand for imparting not only antibacterial properties but also antiviral properties to a molded article.

The present invention has been made in view of the above problems, and an object of the present invention is to provide a novel molded article having antibacterial or antiviral properties, a method for manufacturing the same, and the like.

### Solution to Problem

A molded article according to one embodiment of the present invention comprises a calcium compound, and a resin, and has a salt of inositol phosphate with at least one metal element selected from the group consisting of silver, zinc, and copper on a surface thereof.

Since this molded article has the above-described configuration, the molded article exhibits at least any one of excellent antibacterial properties and excellent antiviral properties. The antibacterial or antiviral properties are considered to be due to the salt of inositol phosphate with the predetermined metal element, and/or metal ions eluted from the salt. Since the molded article has the calcium compound, it is presumed that the salt interacts with the calcium compound and is stably retained on the surface of the molded article.

In the above aspect, the inositol phosphate preferably has three or more and six or less phosphate groups. According to this aspect, since the interaction between the salt of inositol phosphate with the predetermined metal element, and the calcium compound provides more suitable strength, the antibacterial or antiviral properties of the molded article tend to be further excellent. From the same viewpoint, the inositol phosphate is more preferably phytic acid.

In any of the above aspects, the calcium compound is preferably an inorganic salt of calcium. According to this aspect, the interaction between the salt of inositol phosphate with the predetermined metal element, and the calcium compound tends to have a more suitable strength.

In one aspect of the molded article, the molded article comprises a fiber-reinforced plastic layer, and an outer layer that is disposed on the fiber-reinforced plastic layer, and the outer layer comprises the calcium compound and the resin, and has the salt of inositol phosphate with at least one metal element selected from the group consisting of silver, zinc, and copper on a surface thereof. According to this aspect, it is possible to impart excellent antibacterial or antiviral properties to the fiber-reinforced plastic. That is, in this aspect, the molded article has excellent antibacterial or antiviral properties and excellent mechanical properties.

In the above aspect, the average thickness of the outer layer is preferably 0.1 mm or more and 5.0 mm or less. According to the aspect, there is a tendency that the molded article can achieve more excellent antibacterial or antiviral properties and high strength.

In any of the above aspects, the molded article may be a bathtub, a sanitary product, playground equipment, a flower vase, a champagne cooler, a portable toilet box, a washing tub, stationery, an automobile handle, a door knob, a food court tray or table, a station or park bench, or an interior member of a vehicle, an aircraft, or a building.

A method for manufacturing a molded article according to one embodiment of the present invention comprises a step of applying inositol phosphate to at least a part of a surface of a molded article of a resin composition comprising a calcium compound and a resin, and a step of applying at least one metal ion selected from the group consisting of a silver ion, a zinc ion, and a copper ion to the surface to which the inositol phosphate is applied.

According to this manufacturing method, a novel molded article having excellent antibacterial or antiviral properties can be easily manufactured.

A method for manufacturing a fiber-reinforced plastic product according to one embodiment of the present invention comprises a step of applying inositol phosphate to a surface of an outer layer of a fiber-reinforced plastic which comprises the outer layer comprising a calcium compound and a resin on at least a part of a surface thereof, and a step of applying at least one metal ion selected from the group consisting of a silver ion, a zinc ion, and a copper ion to the surface to which the inositol phosphate is applied.

According to this manufacturing method, a novel fiber-reinforced plastic product having excellent antibacterial or antiviral properties can be easily manufactured.

In any of the above manufacturing methods, the step of applying the inositol phosphate may be a step of bringing the surface to which the inositol phosphate is applied into contact with an aqueous solution comprising inositol phosphate.

A method for improving or imparting antibacterial or antiviral properties of a molded article comprising a calcium compound and a resin and having inositol phosphate on a surface thereof according to one embodiment of the present invention comprises a step of applying at least one metal ion selected from the group consisting of a silver ion, a zinc ion, and a copper ion to the surface having the inositol phosphate.

According to this method, antibacterial or antiviral properties can be very easily improved or imparted to a molded article which has lost antibacterial or antiviral properties or has lowered antibacterial or antiviral properties.

In the above method, the molded article may be a molded article that has lost antibacterial or antiviral properties. This aspect relates to a method for restoring antibacterial or antiviral properties of the molded article.

In the above method, the molded article may comprise a fiber-reinforced plastic layer, and an outer layer that is disposed on the fiber-reinforced plastic layer, and the outer layer may comprise the calcium compound and the resin, and may have inositol phosphate on a surface thereof. According to this aspect, antibacterial or antiviral properties can be very easily improved or imparted to a fiber-reinforced plastic that has lost antibacterial or antiviral properties or has lowered antibacterial or antiviral properties.

### Advantageous Effects of Invention

According to the present invention, it is possible to provide a novel molded article having antibacterial or antiviral properties, a method for manufacturing the same, and the like.

### BRIEF DESCRIPTION OF DRAWINGS

FIG. 1 is a schematic cross-sectional view of a molded article according to the present embodiment.

FIG. 2 is a schematic cross-sectional view of an aspect of a surface of the molded article according to the present embodiment.

FIG. 3 is a schematic cross-sectional view of a fiber-reinforced plastic product according to the present embodiment.

FIG. 4 is a schematic cross-sectional view showing one step in one example of a method for manufacturing the molded article according to the present embodiment.

FIG. 5 is a schematic cross-sectional view showing another step in one example of the method for manufacturing the molded article according to the present embodiment.

FIG. 6 is a schematic cross-sectional view showing one step in one example of a method for manufacturing the fiber-reinforced plastic product according to the present embodiment.

FIG. 7 is a schematic cross-sectional view showing another step in one example of the method for manufacturing the fiber-reinforced plastic product according to the present embodiment.

FIG. 8 is a schematic cross-sectional view showing still another step in one example of the method for manufacturing the fiber-reinforced plastic product according to the present embodiment.

FIG. 9 is a diagram showing a relationship between the concentration of a silver nitrate aqueous solution and the amount of silver supported in the outer layer which is measured by ICP-AES. In the drawing, in the notation “Ag(X)-FRP”, X means the concentration (unit: mM) of the silver nitrate aqueous solution used when preparing the sample. The value of the supported amount in each sample is 25, 211, 610, and 925 in order from Ag(1)-FRP.

FIG. 10 is a diagram showing antibacterial properties of fiber-reinforced plastics of Examples and Control Examples. In the drawing, in the notation “Ag(X)-FRP”, X means the concentration (unit: mM) of the silver nitrate aqueous solution used when preparing the sample. The circles shown below each bar graph are observation photographs of the corresponding samples in a plan view.

FIG. 11 is a diagram showing sustained release of metal ions in a fiber-reinforced plastic. The vertical axis indicates the concentration of eluted metal ion. In the drawing, in the notation “Ag(X)-FRP”, X means the concentration (unit: mM) of the silver nitrate aqueous solution used when preparing the sample.

FIG. 12 is a diagram showing an outline of a protocol in a test for evaluating the restorability of antibacterial properties in Examples.

FIG. 13 is a diagram showing the evaluation result of the restorability of antibacterial properties. In the drawing, in the notation “Ag(X)-FRP”, X means the concentration (unit: mM) of the silver nitrate aqueous solution used when preparing the sample. The circles shown below each bar graph are observation photographs of the corresponding samples in a plan view.

FIG. 14 is a diagram showing observation images of surfaces of fiber-reinforced plastics on the first day after culture. In the drawing, the arrows indicate the cells. In addition, in the notation “Ag(X)”, X means the concentration (unit: mM) of the silver nitrate aqueous solution used when preparing the sample.

FIG. 15 is a diagram showing observation images of the surfaces of the fiber-reinforced plastics on the fourth day after culture. In the drawing, in the notation “Ag(X)”, X means the concentration (unit: mM) of the silver nitrate aqueous solution used when preparing the sample.

FIG. 16 is a diagram showing Live/Dead staining results of the fiber-reinforced plastics on the first day after culture. In the drawing, in the notation “Ag(X)”, X means the concentration (unit: mM) of the silver nitrate aqueous solution used when preparing the sample.

FIG. 17 is a diagram showing Live/Dead staining results of the fiber-reinforced plastics on the fourth day after culture. In the drawing, in the notation “Ag(X)”, X means the concentration (unit: mM) of the silver nitrate aqueous solution used when preparing the sample.

FIG. 18 is a diagram showing the measurement results of the cell number at the start of culture, on the first day after the culture, and on the fourth day after the culture, when the cells are cultured on the fiber-reinforced plastic. Each series is, in order from the left, Control (Plate), FRP, and Ag1 (fiber-reinforced plastic having silver ions immobilized using a 1 mM silver nitrate aqueous solution).

FIG. 19 is a diagram showing an average logarithm value of an infectivity titer per unit area when the virus is cultured on the fiber-reinforced plastic. In the drawing, in the notation “Ag(X)”, X means the concentration (unit: mM) of the silver nitrate aqueous solution used when preparing the sample.

### DESCRIPTION OF EMBODIMENTS

Hereinafter, embodiments (hereinafter, referred to as “the present embodiments”) for carrying out the present invention will be described in detail with reference to drawings as necessary. However, the present invention is not limited thereto, and various modifications are possible without departing from the gist. In addition, in the drawings, the same element will be represented by the same reference numeral and redundant description will be omitted. Unless otherwise specifically described, the positional relationship such as vertical or horizontal one will be based on the positional relationship shown in the drawings. Further, the dimensional ratio in the drawings is not limited to the ratio shown in the drawings. [Molded Article]

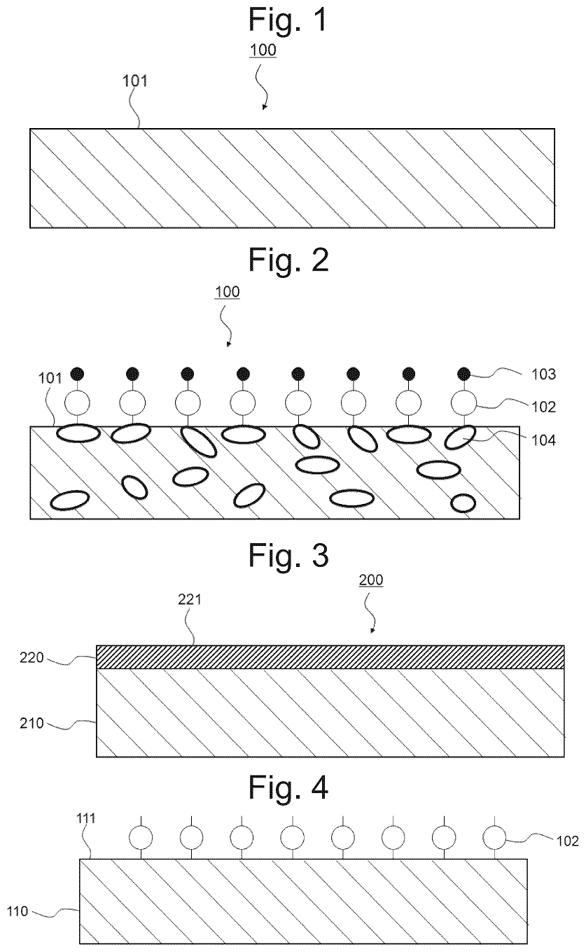

FIG. 1 is a schematic cross-sectional view of a molded article according to the present embodiment. A molded article 100 according to the present embodiment contains a calcium compound and a resin, and has a salt of inositol phosphate with at least one metal element selected from the group consisting of silver, zinc, and copper on a surface 101 thereof.

Since the molded article 100 has such a configuration, the molded article 100 has at least any one of excellent antibacterial properties and antiviral properties.

In the present specification, the term “antibacterial properties” means properties of suppressing bacterial growth or killing bacteria. Therefore, the molded article according to the present embodiment can suppress bacterial growth or kill bacteria on the surface thereof. As an index of the antibacterial properties of the molded article, an antibacterial activity value defined in Examples described later can be used. The molded article according to the present embodiment has preferably an antibacterial activity value of 2.0 or more, and more preferably an antibacterial activity value of 2.5 or more.

In addition, the expression “antiviral properties” in the present specification means properties of reducing the infectivity titer of a virus or suppressing an increase in the infectivity titer of a virus. Therefore, the molded article according to the present embodiment can suppress the growth of the infectious virus or kill the infectious virus on the surface thereof. As an index of the antiviral properties of the molded article, an antiviral activity value defined in Examples described later can be used. The molded article according to the present embodiment has preferably an antiviral activity value of 2.0 or more, and more preferably an antiviral activity value of 3.0 or more.

Hereinafter, each component of the molded article 100 will be described in detail.

### (Calcium Compound and Resin)

The molded article 100 contains a resin and a calcium compound. The molded article 100 may be obtained by dispersing a calcium compound using a resin (synonymous with polymer and polymer) as a matrix material. The molded article 100 may be a molded article of a resin composition containing a calcium compound and a resin, or may be a cured product of a resin composition containing a calcium compound and a resin. Since the molded article contains a resin, the calcium compound is not easily detached and is firmly retained in the molded article.

In the present specification, the term “resin” includes not only a resin before curing and/or crosslinking but also a cured resin and/or a crosslinked resin.

Examples of the resin contained in the molded article 100 include a thermoplastic resin, a thermosetting resin, and the like, but the resin is not particularly limited. From the viewpoint of improving the strength of the molded article 100, it is preferable to contain a thermosetting resin.

Examples of the thermosetting resin that can be contained in the molded article 100 include an unsaturated polyester resin, a phenol resin, a polyamide resin, an epoxy resin, a vinyl ester resin, a polyimide resin, a urea resin, a melamine resin, and the like.

Examples of the thermoplastic resin that can be contained in the molded article 100 include an acrylic resin, an acrylonitrile-butadiene styrene (ABS) resin, a polyethylene resin, a polycarbonate resin, a polyamide resin, a polypropylene resin, and the like.

As the resin contained in the molded article 100, any one of an unsaturated polyester resin, a vinyl ester resin, and a mixed resin of an unsaturated polyester resin and a vinyl ester resin is preferably used. According to the aspect, the strength of the molded article increases, and there is a tendency that the calcium compound can be more reliably prevented from being detached from the molded article. In addition, the mixing ratio of each resin in the above mixed resin is not particularly limited.

The above resins may be used alone or in combination of two or more thereof.

The calcium compound that can be contained in the molded article 100 is not particularly limited as long as the compound is a compound containing a calcium element. The molded article 100 may contain various calcium compounds. From the viewpoint of further strengthening the interaction between the inositol phosphate and the calcium compound on the surface of the molded article 100, the calcium compound is preferably an organic salt or an inorganic salt (hereinafter, referred to as “organic salt of calcium” and “inorganic salt of calcium”, respectively) containing calcium ions (more specifically, Ca2⁺). From the same viewpoint, the calcium compound is more preferably an inorganic salt of calcium.

Examples of the inorganic salt of calcium that can be contained in the molded article 100 include calcium phosphate, calcium hydrogen phosphate, calcium sulfate, calcium carbonate, calcium oxide, calcium silicate, and the like. Examples of the calcium phosphate include tricalcium phosphate, tetracalcium phosphate, octacalcium phosphate, hydroxyapatite (Ca₁₀(PO₄)₆(OH)₂), and the like. Examples of the calcium hydrogen phosphate include calcium monohydrogen phosphate and calcium dihydrogen phosphate. Examples of the organic salt of calcium include calcium acetate.

The calcium compound may be one in which part of the calcium element in the above compound is substituted with a magnesium element.

Preferable forms of the calcium compound include calcium carbonate, calcium sulfate, calcium oxide, and hydroxyapatite. According to the forms, the interaction between the inositol phosphate and the calcium compound on the surface of the molded article 100 is further strengthened. From the same viewpoint, more preferable forms of the calcium compound include calcium carbonate and hydroxyapatite. The calcium compound is even more preferably calcium carbonate.

The molded article 100 may contain the above-described calcium compounds alone or in combination of two or more thereof.

The calcium compound may be contained in the form of particles. The particle diameter of the calcium compound particle is not particularly limited, but is preferably equal to or less than the average thickness of the molded article 100, more preferably one-fifth or less of the average thickness of the molded article, and even more preferably one-tenth or less of the average thickness of the molded article. More specifically, the particle diameter of the calcium compound particle is preferably 1 μm or more and 400 μm or less, more preferably 5 μm or more and 200 μm or less, and even more preferably 10 μm or more and 100 μm or less. The particle diameter of the calcium compound particle may be 10 μm or more and 50 μm or less.

The particle diameter of the calcium compound particle is determined by calculating circle equivalent diameters of three or more calcium compound particles in an observation image of the cross section of the molded article 100 as shown in FIG. 2, which will be described later, observed with a scanning electron microscope (SEM), and calculating the average value thereof. In the method for calculating the particle diameter, it is preferable to obtain an arithmetic average of the circle equivalent diameters of ten or more calcium compound particles. In the present embodiment, when calcium compound fine particles having a particle diameter of about several μm are used when manufacturing the molded article, the calcium compound fine particles usually tend to form aggregate particles having a particle diameter of about 10 to 100 μm due to aggregation. In such a case, since the calcium compound particles observed by SEM observation are such aggregates, the average particle diameter of the aggregates is defined as the particle diameter of the calcium compound. However, the above description is not intended to exclude from the present embodiment an aspect in which the calcium compound fine particles are dispersed in the molded article without forming aggregates. In order to confirm that the calcium compound observed by the SEM is an aggregate of fine particles of the calcium compound, the calcium compound may be observed with, for example, a transmission electron microscope (TEM).

In addition, the average thickness of the molded article is determined by measuring the thickness of the molded article at three or more positions in an observation image of the cross section of the molded article with an optical microscope or the like as shown in FIG. 1, and calculating the arithmetic average thereof.

More specifically, the average thickness of the molded article is obtained as follows. First, the molded article is cut in a direction substantially parallel to the thickness direction thereof, and the exposed cross section is observed from a direction substantially perpendicular to the cross section. A scanning electron microscope (SEM), a transmission electron microscope (TEM), or an optical microscope can be used for the observation. In the obtained observation image, the thickness of the molded article is measured at three or more positions, preferably five positions, and more preferably ten positions. The arithmetic average of the obtained each value is calculated, and the value is used as an average thickness of the molded article.

The molded article 100 may contain, as components other than the calcium compound and the resin, a filler well-known in the related art (excluding the calcium compound), a curing agent for curing the resin, and an additive such as a coating material or the like.

The contents of the resin and the calcium compound in the molded article 100 are not particularly limited.

The calcium compound may be contained in an amount of 20% by mass or more and 60% by mass or less, or may be contained in an amount of 30% by mass or more and 60% by mass or less, with respect to the entire molded article.

The resin may be contained in an amount of 5.0% by mass or more and 60% by mass or less or may be contained in an amount of 10% by mass or more and 40% by mass or less, with respect to the entire molded article.

### (Surface of Molded Article)

The molded article 100 has a salt of inositol phosphate with at least one metal element selected from the group consisting of silver, zinc, and copper on the surface 101. In the present specification, “at least one metal element selected from the group consisting of silver, zinc, and copper” is sometimes simply referred to as a “metal element” or “predetermined metal element”.

The inositol phosphate means inositol phosphate in which one or more of six hydroxyl groups of inositol (1,2,3,4,5,6-cyclohexanehexaol) are substituted with a phosphate group (—OP(═O)(OH)₂). Specific examples of the inositol phosphate include inositol monophosphate, inositol diphosphate, inositol triphosphate, inositol tetraphosphate, inositol pentaphosphate, and inositol hexaphosphate (which are compounds in which the hydroxyl groups of inositol are substituted with phosphoric acid at 1, 2, 3, 4, 5, and 6 positions, respectively).

Since the inositol phosphate has a large number of OH groups (OH groups directly bonded to the cyclohexane ring and OH groups in the phosphate group), the inositol phosphate can be coordinated with metal atoms or metal ions at plural coordination sites.

The present inventors have found that since the molded article 100 contains a calcium compound and a resin, and has a salt of inositol phosphate with a predetermined metal element on the surface 101 thereof, excellent antibacterial or antiviral properties are exhibited. It is presumed that such antibacterial or antiviral properties are derived from the salt of inositol phosphate with the predetermined metal element retained on the surface 101, and/or metal ions eluted from the salt. In addition, the antibacterial or antiviral properties of the molded article according to the present embodiment tend to maintain the effect for a long period of time. It is presumed that this is because on the surface 101, the inositol phosphate and the calcium compound interact with each other to suppress the elution of the salt of inositol phosphate with the predetermined metal element. The factors why the molded article according to the present embodiment exhibits antibacterial or antiviral properties and why the antibacterial or antiviral properties may maintain the effects for a long period of time are not limited to those described above. In addition, the above description does not limit the duration of the antibacterial properties of the molded article according to the present embodiment.

In the molded article 100, the salt of inositol phosphate with at least one metal element selected from the group consisting of silver, zinc, and copper may be present on the surface 101. Although the form of the salt on the surface 101 is not particularly limited, a schematic cross-sectional view of one form thereof is shown in FIG. 2.

In FIG. 2, the molded article 100 contains a calcium compound 104 such that at least a part of the calcium compound 104 is exposed on the surface 101. Since inositol phosphate has a property of coordinating with a calcium element (calcium metal and/or calcium ion), an inositol phosphate 102 is coordinated with the exposed calcium compound 104 on the surface 101. In addition, since inositol phosphate also has a property of coordinating with silver, zinc, and copper, and has a coordination site different from the coordination site in which the inositol phosphate is coordinated with the calcium compound 104, a metal element 103 (which is at least one metal element selected from the group consisting of silver, zinc, and copper) is further coordinated with the inositol phosphate 102 coordinated with the calcium compound 104. In addition, it can also be considered that in FIG. 2, the inositol phosphate 102 and the metal element 103 form a salt and the salt is supported on the calcium compound 104.

As described above, in one aspect of the molded article according to the present embodiment, on the surface 101, the metal element 103 is retained by the calcium compound 104 via the inositol phosphate 102.

The present inventors presume that the salt of inositol phosphate with the metal element and/or metal ions eluted from the salt contribute to the antibacterial or antiviral properties of the molded article. Since the salt of inositol phosphate with the metal element is retained on the surface 101 of the molded article 100 as described above, it is presumed that the dissociation constant of the salt of inositol phosphate with the metal element or the dissociation constant of the metal ion is within a preferable range, and as a result, the molded article 100 can exhibit sufficient antibacterial or antiviral properties for a long period of time.

However, although the presence of the salt of inositol phosphate with the metal element on the surface 101 can be easily detected by surface analysis or the like, it is not always easy to detect the presence of the salt of inositol phosphate and the metal element in the aspect as shown in FIG. 2. From this viewpoint, the salt of inositol phosphate with the metal element does not necessarily need to be present on the surface 101 in the aspect as shown in FIG. 2. For example, the metal element may be directly supported on the surface 101, and the metal element may interact with inositol phosphate.

The inositol phosphate that the molded article 100 has is not particularly limited, and may be inositol monophosphate, inositol diphosphate, inositol triphosphate, inositol tetraphosphate, inositol pentaphosphate, or inositol hexaphosphate.

It is preferable that the inositol phosphate has three or more and six or less phosphate groups. According to this aspect, the interaction between the inositol phosphate and the calcium compound and/or the metal element becomes stronger, and the antibacterial or antiviral properties of the molded article 100 tend to be further improved. That is, as the inositol phosphate, one or more selected from the group consisting of inositol triphosphate, inositol tetraphosphate, inositol pentaphosphate, and inositol hexaphosphate is preferable. From the same viewpoint, the inositol phosphate more preferably has four or more and six or less phosphate groups, even more preferably has five or more and six or less phosphate groups, and particularly preferably has six phosphate groups.

The three-dimensional structure of inositol to which the phosphate group in the inositol phosphate is bonded is not particularly limited, and examples thereof include myo-inositol, scyllo-inositol, muco-inositol, chiro-inositol, neo-inositol, allo-inositol, epi-inositol, cis-inositol, and the like. The inositol phosphate is preferably inositol phosphate derived from myo-inositol (that is, inositol phosphate in which at least one of the hydroxyl groups of myo-inositol is substituted with a phosphate group). According to this aspect, the balance between the interaction between the inositol phosphate and the calcium compound and the interaction between the inositol phosphate and the metal element is further improved, and the antibacterial or antiviral properties of the molded article 100 tend to be further improved.

As a preferable form of the inositol phosphate, one in which three or more and six or less phosphate groups are bonded to myo-inositol (one in which three or more and six or less hydroxyl groups of the hydroxyl groups of myo-inositol are phosphorylated; the same applies in this paragraph) is exemplified, more preferably, one in which four or more and six or less phosphate groups are bonded to myo-inositol is exemplified, even more preferably, one in which five or more and six or less phosphate groups are bonded to myo-inositol is exemplified, and still even more preferably, one in which six phosphate groups are bonded to myo-inositol is exemplified.

As another preferable form of the inositol phosphate, inositol hexaphosphate is exemplified, and in particular, phytic acid (myo-inositol-1,2,3,4,5,6-hexaphosphate) is exemplified.

The molded article 100 may contain the above-described inositol phosphates alone or in combination of two or more thereof.

On the surface 101, at least one metal element selected from the group consisting of silver, zinc, and copper forms a salt with inositol phosphate. As described above, it is considered that the molded article 100 exhibits antibacterial or antiviral properties due to the salt and/or metal ions eluted from the salt. The fact that the surface 101 has a salt of inositol phosphate and the metal element can be rephrased as that the surface 101 has inositol phosphate ions and metal ions.

Inositol phosphate may form a salt with at least one metal element selected from the group consisting of silver, zinc, and copper. This means that at least one of a salt of inositol phosphate with silver, a salt of inositol phosphate with zinc, and a salt of inositol phosphate with copper is present on the surface 101.

From the viewpoint of further improving the antibacterial or antiviral property, it is preferable that the surface 101 contains silver. That is, the molded article 100 preferably has at least a salt of inositol phosphate with silver (a salt of inositol phosphate ions with silver ions) on the surface 101. Alternatively, it is preferable that the surface 101 contains at least one of silver and zinc.

When the surface 101 has two or more metal elements, the ratio of each metal element is not particularly limited. Examples of preferable forms of the metal element on the surface 101 include silver alone, zinc alone, and a combination of silver and zinc.

The amount of the metal element supported on the surface 101 is not particularly limited. The amount of the metal element supported may be, for example, 10 mg/cm² or more and 2000 mg/cm² or less. In the above range, the amount of the metal element supported is preferably 15 mg/cm² or more and 1000 mg/cm² or less, more preferably 15 mg/cm² or more and 800 mg/cm² or less, and even more preferably 20 mg/cm² or more and 400 mg/cm² or less.

The amount of the metal element supported may be, for example, 0.093 mmol/cm² or more and 18.55 mmol/cm² or less on molar basis. In the above range, the amount of the metal element supported is preferably 0.14 mmol/cm² or more and 9.276 mmol/cm² or less, more preferably 0.14 mmol/cm² or more and 7.42 mmol/cm² or less, and even more preferably 1.9 mmol/cm² or more and 3.71 mmol/cm² or less.

In addition, as a method for measuring the amount of the metal element supported, a method for performing measurement using ICP-AES as described in Examples may be used. Further, the measurement may be performed by a surface analysis method such as EDS (enhanced energy dispersion X-ray spectroscopy), AES (Auger electron spectroscopy), XPS (X-ray photoelectron spectroscopy), or the like.

### (Shape of Molded Article)

The shape of the molded article according to the present embodiment is not particularly limited, and may be a plate shape, a spherical shape, a cylindrical shape, or a columnar shape, or may be a three-dimensional shape including a flat surface having irregularities.

In addition, the molded article according to the present embodiment may be a final product by itself, or may be a member constituting the final product.

The molded article according to the present embodiment may be a combination of two or more different materials as in the fiber-reinforced plastic product according to the present embodiment, which will be described later.

In a case where the molded article according to the present embodiment is formed by a combination of two or more different materials, at least one material may contain a calcium compound and a resin, and a salt of inositol phosphate with at least one metal element selected from the group consisting of silver, zinc, and copper may be formed on the surface thereof. In addition, in such a case, the surface having the salt of inositol phosphate with the metal element does not necessarily have to be exposed on the surface of the molded article. For example, in a case where the molded article is hollow, in a member constituting the hollow portion of the molded article, an inner surface (that is, a portion corresponding to the inside of the molded article) may have the salt of inositol phosphate with the metal element.

In the molded article according to the present embodiment, the entire surface of the molded article does not need to have the salt of inositol phosphate with the metal element. In the molded article according to the present embodiment, as shown in FIGS. 1 and 2, a part of the surface of the molded article may contain the salt of inositol phosphate with the metal element. That is, the molded article according to the present embodiment has the salt of inositol phosphate with the metal element on at least a part of the surface of the molded article.

The ratio of the surface of the molded article having the salt of inositol phosphate with the metal element to the total surface of the molded article is not particularly limited, and a configuration may be employed in which in particular, the salt of inositol phosphate with the metal element is formed in a portion to which antibacterial or antiviral properties are to be imparted.

### (Effect of Molded Article)

The molded article according to the present embodiment is superior to the conventional plastic products having antibacterial properties as shown below in the following points.

### 1. Zeolite-Containing Type Plastic Product

A zeolite-containing type plastic product is an antibacterial plastic product in which zeolite containing metal ions (typically silver ions) is kneaded into a resin. Therefore, since the zeolite-containing type plastic product requires a zeolite containing metal ions, the manufacturing cost is high. On the other hand, the molded article according to the present embodiment does not need to use such a special material, is easily manufactured, and has a low manufacturing cost. In addition, since the metal ions in zeolite tend to be easily eluted, the antibacterial properties of the zeolite-containing type plastic product do not last for a long period of time. However, in the molded article according to the present embodiment, the metal element is firmly retained on the surface of the molded article by the interaction of the metal element with inositol phosphate, and the durability of antibacterial properties tends to be high.

### 2. Metal Fine Particle-Containing Type Plastic Product

A metal fine particle-containing type plastic product is an antibacterial plastic product in which metal fine particles (typically, silver fine particles) are kneaded into a resin or supported on the surface of the resin. In general, since the antibacterial properties exhibited by metal fine particles are less effective than the antibacterial properties exhibited by metal ions, the metal fine particle-containing type plastic product exhibits lower antibacterial properties than a product that exhibits antibacterial properties due to metal ions or a salt containing a metal element.

Further, in an antibacterial plastic product in which metal fine particles are supported on the surface of the plastic, there is a problem that the metal fine particles aggregate on the surface of the product and the antibacterial properties are lowered. However, the molded article according to the present embodiment does not have such a problem.

### 3. Coating Type Antibacterial Plastic Product

A coating type antibacterial plastic product is an antibacterial plastic product in which a plastic surface is coated with a coating agent (typically, a coating agent containing silver ions) for imparting antibacterial properties. Although such a product can be easily manufactured, the antibacterial substance in the coating agent is not firmly retained on the surface of the plastic product. Therefore, the antibacterial substance is easily eluted and the antibacterial properties are less likely to last for a long period of time. On the other hand, in the molded article according to the present embodiment, the metal element is firmly retained on the surface of the molded article by the interaction with inositol phosphate, and the durability of the antibacterial properties tends to be high.

In addition, any of the above-described plastic products 1 to 3 having antibacterial properties is not a fiber-reinforced plastic reinforced by a fiber material. One of the advantages according to the present embodiment is that, as will be described later, excellent antibacterial properties can be easily imparted to a fiber-reinforced plastic product.

Further, the molded article according to the present embodiment can exhibit not only antibacterial properties but also antiviral properties. In some cases, it may not be confirmed that the plastic products 1 to 3 having the antibacterial properties described above have antiviral properties, and the molded article according to the present embodiment has an advantageous effect in this point as well.

In addition, in the molded article according to the present embodiment, it is considered that since the salt retained on the surface or the metal ions eluted from the salt exhibit antibacterial or antiviral properties, even when the metal element is eluted due to long term use and the antibacterial or antiviral properties are lowered, the antibacterial or antiviral properties can be easily improved or restored by newly applying metal ions on the surface of the molded article. On the other hand, in the zeolite-containing type plastic product and metal fine particle-containing type plastic product described above, the antibacterial properties cannot be improved by such a method, and once the antibacterial properties are lowered, the antibacterial properties are not easily improved.

Further, the present inventors have found that the molded article according to the present embodiment not only has excellent antibacterial or antiviral properties as described above, but also tends to have low cytotoxicity (toxicity to eukaryotic (particularly mammalian) cells). In general, in a case where antibacterial properties are exhibited due to metal ions, the higher the concentration or the amount of the metal ion supported, the higher the antibacterial properties tend to be. However, when the concentration or the amount of the metal ion supported is increased in order to enhance the antibacterial properties, cytotoxicity is also improved, that is, there is a possibility of having unfavorable effects on animals, including humans. From this viewpoint, since the molded article according to the present embodiment does not simply have metal ions on the surface, but has a salt of inositol phosphate with the metal element, it is considered that in addition to excellent antibacterial or antiviral properties, sufficiently low cytotoxicity can be achieved. More specifically, in the molded article according to the present embodiment, a relative cell growth ratio M, which is defined in Example to be described later, is preferably 70% or more, and more preferably 80% or more.

### (Application of Molded Article)

The molded article according to the present embodiment can be used for various applications, and is particularly preferably used for applications in which antibacterial or antiviral properties are required. In one aspect, the molded article according to the present embodiment is used as an antibacterial or antiviral product or member. The molded article according to the present embodiment is suitably used, for example, for an interior member of a vehicle, an aircraft, a building, and the like, with which a plurality of people can frequently come into contact, a bathtub and a sanitary product which require a high level of hygiene, and the like. Examples of the applications of the molded article according to the present embodiment include a bathtub, a sanitary product, playground equipment, a flower vase, a champagne cooler, a portable toilet box, a washing tub, stationery, an automobile handle, a door knob, a food court tray or table, a station or park bench, and an interior member of a vehicle, an aircraft, and a building.

### [Fiber-Reinforced Plastic Product]

One aspect of the molded article according to the present embodiment is a fiber-reinforced plastic product. In the present specification, this aspect is referred to as a “fiber-reinforced plastic product according to the present embodiment”. FIG. 3 is a schematic cross-sectional view of the fiber-reinforced plastic product according to the present embodiment. A fiber-reinforced plastic product 200 according to the present embodiment includes a fiber-reinforced plastic layer 210 and an outer layer 220 that is disposed on the fiber-reinforced plastic layer 210. The outer layer 220 is a layer containing a calcium compound and a resin. Further, the outer layer 220 has a salt of the inositol phosphate with at least one metal element selected from the group consisting of silver, zinc, and copper, on a surface 221 thereof, which is not shown in FIG. 3. Since the fiber-reinforced plastic product 200 has such a component, the fiber-reinforced plastic product has antibacterial or antiviral properties. Therefore, the fiber-reinforced plastic product according to the present embodiment can suppress bacterial growth or kill bacteria on the surface, particularly on the surface of the outer layer.

Hereinafter, each component of the fiber-reinforced plastic product 200 will be described in detail, but redundant description for the molded article 100 will be omitted. In comparison with the molded article 100, the fiber-reinforced plastic product 200 is characterized in that the fiber-reinforced plastic product 200 is configured with two members, one member is the fiber-reinforced plastic, the other member includes a resin and a calcium compound and has a predetermined salt on a surface thereof.

### (Fiber-Reinforced Plastic Layer)

The fiber-reinforced plastic layer 210 contains a fiber material and a resin. Therefore, the fiber-reinforced plastic product 200 is a product that has light weight and is less likely to rust and corrode while having excellent mechanical properties such as high strength, high elastic modulus, and the like.

A fiber material contained in the fiber-reinforced plastic layer is not particularly limited as long as the material is a fibrous material, and examples thereof include aramid fibers, natural fibers, metal fibers, glass fibers, and carbon fibers. The fiber material contained in the fiber-reinforced plastic layer 210 is preferably glass fiber or a carbon fiber, and more preferably a glass fiber. A fiber-reinforced plastic containing glass fibers is referred to as GFRP, and a fiber-reinforced plastic containing carbon fibers is referred to as CFRP. The fiber-reinforced plastic layer 210 may contain the above-described fiber materials alone or in combination of two or more thereof.

Examples of the resin contained in the fiber-reinforced plastic layer include a thermoplastic resin and a thermosetting resin, but the resin is not particularly limited. From the viewpoint of improving the strength of the fiber-reinforced plastic product 200, the fiber-reinforced plastic layer preferably contains a thermosetting resin.

Examples of the thermosetting resin that can be contained in the fiber-reinforced plastic layer include an unsaturated polyester resin, a phenol resin, a polyamide resin, an epoxy resin, a vinyl ester resin, a polyimide resin, a urea resin, a melamine resin, and the like.

Examples of the thermoplastic resin that can be contained in the fiber-reinforced plastic layer include a polyamide resin, a polypropylene resin, and the like.

The above resins may be used alone or in combination of two or more thereof.

The fiber-reinforced plastic layer 210 may contain, as components other than the fiber material and the resin, a filler well-known in the related art (excluding the fiber material), a curing agent for curing the resin, and an additive such as a coating material or the like. In addition, the shape and thickness of the fiber-reinforced plastic layer 210 are not particularly limited, and can be appropriately adjusted according to the application of the fiber-reinforced plastic product.

### (Outer Layer)

As shown in FIG. 3, in the fiber-reinforced plastic product 200, the outer layer 220 is disposed on the fiber-reinforced plastic layer 210. That is, in the fiber-reinforced plastic product 200, at least a part of the surface of the fiber-reinforced plastic layer 210 is covered by the outer layer 220, and the outer layer 220 is exposed in a direction opposite to the fiber-reinforced plastic layer 210. The outer layer 220 contains a calcium compound and a resin, and has a salt of inositol phosphate with at least one metal element selected from the group consisting of silver, zinc, and copper on the surface 221.

The outer layer 220 may have the same configuration as the molded article 100.

In addition, the surface 221 of the outer layer 220 may have the same configuration as the surface 101 of the molded article 100. That is, as shown in FIG. 2, the surface 221 may have the calcium compound 104 exposed on the surface, the inositol phosphate 102 retained on the calcium compound, and the metal element 103 that is coordinated with the inositol phosphate.

Examples of the calcium compound contained in the outer layer and preferable aspects are the same as those of the calcium compound contained in the molded article 100.

The outer layer 220 may contain the above-described calcium compounds alone or in combination of two or more. The content of the calcium compound in the outer layer 220 is not particularly limited. The calcium compound may be contained in an amount of, for example, 20% by mass or more and 60% by mass or less, or may be contained in an amount of 30% by mass or more and 60% by mass or less, with respect to the entire outer layer.

The particle diameter of the calcium compound in the outer layer 220 is not particularly limited, but is preferably equal to or less than the average thickness of the outer layer, more preferably one-fifth or less of the average thickness of the outer layer, and even more preferably one-tenth or less of the average thickness of the outer layer. More specifically, the particle diameter of the calcium compound is preferably 1 μm or more and 400 μm or less, more preferably 5 μm or more and 200 μm or less, and even more preferably 10 μm or more and 100 μm or less. The particle diameter of the calcium compound may be 10 μm or more and 50 μm or less. The method for measuring the particle diameter of the calcium compound is the same as above.

Examples of the resin contained in the outer layer 220 include a thermoplastic resin and a thermosetting resin, but the resin is not particularly limited. From the viewpoint of improving the strength of the fiber-reinforced plastic product 200, the outer layer preferably contains a thermosetting resin.

Examples of the thermosetting resin that can be contained in the outer layer include an unsaturated polyester resin, a phenol resin, a polyamide resin, an epoxy resin, a vinyl ester resin, a polyimide resin, a urea resin, a melamine resin, and the like.

Examples of the thermoplastic resin that can be contained in the outer layer include a polyamide resin, a polypropylene resin, and the like.

As the resin contained in the outer layer 220, any one of an unsaturated polyester resin, a vinyl ester resin, and a mixed resin of an unsaturated polyester resin and a vinyl ester resin is preferable. According to the aspect, the strength of the outer layer is increased, and there is a tendency that the calcium compound can be more reliably prevented from being detached from the outer layer. In addition, the mixing ratio of each resin in the above mixed resin is not particularly limited.

The content of the resin in the outer layer 220 is not particularly limited. The content of the resin may be appropriately adjusted so that the content of the calcium compound in the outer layer is within the above range.

The outer layer 220 may contain, as components other than the calcium compound and the resin, a filler well-known in the related art (excluding the calcium compound), a curing agent for curing the resin, and an additive such as a coating material or the like. The outer layer 220 may have a fiber material, but preferably does not have a fiber material.

The average thickness of the outer layer 220 is not particularly limited, and can be appropriately changed depending on the application of the fiber-reinforced plastic product 200, the required mechanical strength, and the like. The average thickness of the outer layer is preferably 0.1 mm or more and 5.0 mm or less. According to this aspect, there is a tendency that the fiber-reinforced plastic product 200 can achieve more excellent antibacterial or antiviral properties and high strength. The average thickness of the outer layer may be 0.2 mm or more, 0.3 mm or more, or 3.0 mm or less, or 2.0 mm or less. The average thickness of the outer layer may be a value within a range obtained by arbitrarily selecting the above lower limit value and upper limit value.

In addition, the average thickness of the outer layer is determined by measuring the thickness of the outer layer 220 at three or more positions in an observation image of the cross section of the outer layer 220 obtained by observing the cross section of the outer layer 220 with an optical microscope or the like as shown in FIG. 3, and calculating the arithmetic average thereof.

More specifically, the average thickness of the outer layer is obtained as follows. First, the fiber-reinforced plastic product is cut in a direction substantially parallel to the thickness direction thereof, and the exposed cross section is observed from a direction substantially perpendicular to the cross section. A scanning electron microscope (SEM), a transmission electron microscope (TEM), or an optical microscope can be used for the observation. In the obtained observation image, the thickness of the outer layer, which is a layer containing the resin and the calcium compound, is measured at 3 or more positions, preferably five positions, and more preferably ten positions. The arithmetic average of the obtained each value is calculated, and the value is used as an average thickness of the outer layer.

In addition, in FIG. 3, the outer layer 220 is disposed on only one surface of the fiber-reinforced plastic product 200, but in another embodiment, the outer layer may cover the entire surface of the fiber-reinforced plastic product. The ratio of an area occupied by the outer layer to the surface of the fiber-reinforced plastic product is not particularly limited, and the outer layer may be disposed particularly at a portion to which antibacterial or antiviral properties are to be imparted.

Further, in FIG. 3, the fiber-reinforced plastic product 200 has a two-layer structure of the fiber-reinforced plastic layer 210 and the outer layer 220, but in another embodiment, the fiber-reinforced plastic product may include other layers.

### (Shape of Fiber-Reinforced Plastic Product)

The shape of the fiber-reinforced plastic product according to the present embodiment is not particularly limited, and may be a plate shape, a spherical shape, a cylindrical shape, or a columnar shape, or may be a three-dimensional shape including a flat surface having irregularities.

### (Application of Fiber-Reinforced Plastic Product)

The fiber-reinforced plastic product according to the present embodiment can be used for various applications, but it is preferably used for a member that requires antibacterial or antiviral properties. For example, the fiber-reinforced plastic product is suitably used for an interior member of a vehicle, an aircraft, a building, and the like, with which a plurality of people can frequently come into close contact, a bathtub and a sanitary product which require a high level of hygiene, and the like. Examples of the applications of the fiber-reinforced plastic product according to the present embodiment include a bathtub, a sanitary product, playground equipment, a flower vase, a champagne cooler, a portable toilet box, a washing tub, stationery, an automobile handle, a door knob, a food court tray or table, a station or park bench, and an interior member of a vehicle, an aircraft, and a building.

### [Method for Manufacturing Molded Article]

A method for manufacturing the molded article according to the present embodiment is not particularly limited. For example, it is possible to use the method for manufacturing the molded article according to the present embodiment, which will be described in detail below.

The method for manufacturing the molded article according to the present embodiment includes (1) a step of applying inositol phosphate to at least a part of a surface of a molded article of a resin composition containing a calcium compound and a resin (hereinafter, referred to as “step A1”), and (2) a step of applying at least one metal ion selected from the group consisting of a silver ion, a zinc ion, and a copper ion to the surface, to which the inositol phosphate is applied, obtained in step A1 (hereinafter, referred to as “step A2”).

Hereinafter, each step will be described. For convenience, a step of forming a resin composition containing a calcium compound and a resin (hereinafter, referred to as “step A0”) will also be described, but the method for manufacturing the molded article according to the present embodiment may not include step A0. For example, instead of step A0, a molded article of a resin composition containing a commercially available calcium compound and a resin may be prepared.

### (Step A0)

First, a resin composition containing a calcium compound and a resin is formed. More specifically, step A0 may be performed as follows.

First, the calcium compound as described above and, optionally, other additives are added to the resin as described above to obtain a resin composition. The resin composition is formed by an appropriate method and thereby obtaining a molded article of the resin composition. The molded article of the resin composition may be a cured product of the resin composition.

As a method for molding the resin composition, various known methods can be used depending on a desired shape of the molded article and the type of resin to be used. Examples of the molding method include injection molding, blow molding, extrusion molding, casting, vacuum molding, compression molding, press molding, hand lay-up, and the like.

### (Step A1)

Next, inositol phosphate is applied to at least a part of the surface of the molded article obtained in step A0. That is, as shown in FIG. 4, step A1 is a step of applying the inositol phosphate 102 to the surface 111 of a molded article 110 of the resin composition. As the inositol phosphate, the above-described ones may be imparted.

Examples of a method for applying the inositol phosphate to the surface 111 of the molded article 110 include a method for performing coating or spraying on the surface of the molded article 110 with a solution containing inositol phosphate and/or a salt thereof; and a method for bringing the surface of the molded article 110 into contact with a solution containing inositol phosphate and/or a salt thereof for a certain period of time, and the like. As the method for bringing the surface of the molded article 110 into contact with the solution containing inositol phosphate and/or a salt thereof for a certain period of time, for example, a method for immersing the molded article 110 in a solution containing inositol phosphate and/or a salt thereof and the like may be used. Step A1 preferably includes a step of bringing the surface 111 into contact with the solution containing inositol phosphate and/or a salt thereof for a certain period of time, and more preferably includes a step of immersing the molded article 110 in the solution containing inositol phosphate and/or a salt thereof. The solution used in the above method may be a solution containing inositol phosphate.

Examples of the above-described solution containing inositol phosphate include an aqueous solution of inositol phosphate. In addition, examples of the solution containing a salt of inositol phosphate include an aqueous solution containing any salt of inositol phosphate. The concentration of inositol phosphate in the solution is not particularly limited, and the concentration of inositol phosphate may be, for example, 100 mg/dm³ or more, 500 mg/dm³ or more, 800 mg/dm³ or more, or may be 8000 mg/dm³ or less, 6000 mg/dm³ or less, 4000 mg/dm³ or less, or 2000 mg/dm³ or less. The concentration of inositol phosphate may be a value within a range obtained by arbitrarily selecting the above-described lower limit value and upper limit value. Examples of the salt of inositol phosphate include a sodium salt, a potassium salt of inositol phosphate, and the like.

The pH of the solution containing inositol phosphate is not particularly limited, and may be 3.0 or more, 4.0 or more, 5.0 or more, and 6.0 or more, or 12.0 or less, 11.0 or less, 10.0 or less, 9.0 or less, or 8.0 or less. The pH of the solution may be a value within a range obtained by arbitrarily selecting the above-described lower limit value and upper limit value.

In the step of bringing the surface 111 into contact with the solution containing inositol phosphate and/or a salt thereof for a certain period of time, or in the step of immersing the molded article 110 in the solution containing inositol phosphate and/or a salt thereof, the contact time or the immersion time is not particularly limited, and may be 5 hours or more, 10 hours or more, 15 hours or more, and 20 hours or more, or 60 hours or less, 50 hours or less, 40 hours or less, and 30 hours or less. The contact time or the immersion time may be a value within a range obtained by arbitrarily selecting the above lower limit value and upper limit value.

### (Step A2)

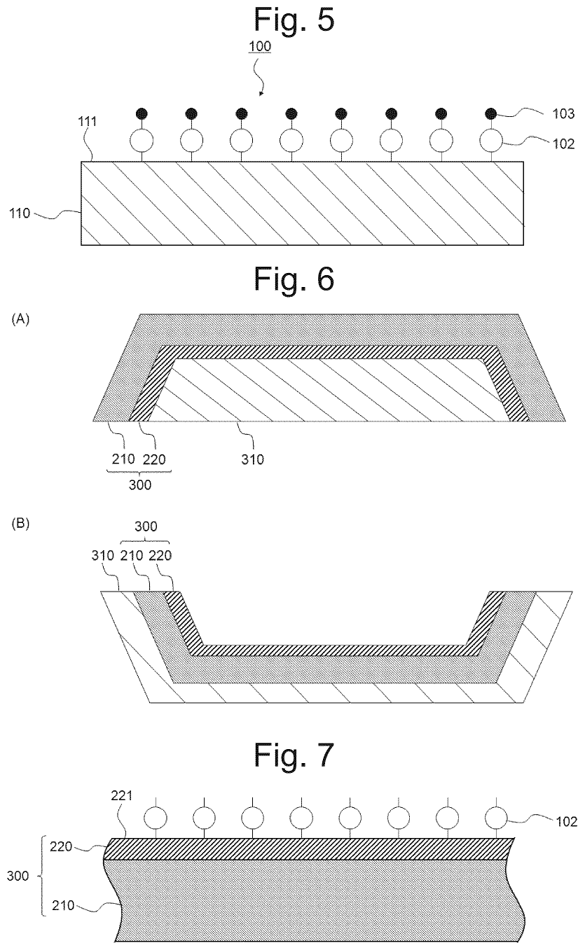

Next, at least one metal ion selected from the group consisting of a silver ion, a zinc ion, and a copper ion is applied to the surface 111 of the molded article 110 having inositol phosphate obtained in step A1. That is, as shown in FIG. 5, step A2 is a step of applying a predetermined metal element 103 (at least one selected from the group consisting of silver, zinc, and copper) to the surface 111 of the molded article 110 having the inositol phosphate 102. The molded article 100 which is the molded article according to the present embodiment is manufactured in such step A2.

As the method for applying metal ions to the surface of the molded article 110, for example, a method for performing coating or spraying on the surface of the molded article 110 with a solution containing metal ions, a method for bringing the surface of the molded article 110 into contact with a solution containing metal ions for a certain period of time, and the like may be used. As the method for bringing the surface of the molded article 110 into contact with the solution containing the metal ions for a certain period of time, for example, a method for immersing the molded article 110 in a solution containing metal ions, and the like may be used. Step A2 preferably includes a step of bringing the surface 111 into contact with a solution containing metal ions for a certain period of time, and more preferably includes a step of immersing the molded article 110 in a solution containing metal ions.

Examples of the solution containing the metal ions include an aqueous solution of an inorganic salt containing the metal ions. The anion in such an inorganic salt is not particularly limited, and examples thereof include a nitrate ion, a sulfate ion, a carbonate ion, and the like.

The concentration of the metal ion in the solution is not particularly limited, and for example, the concentration of the metal ion may be 0.1 mM or more, 1.0 mM or more, and 3.0 mM or more, or 500 mM or less, 200 mM or less, 100 mM or less, and 50 mM or less. The concentration of the metal ion may be a value within a range obtained by arbitrarily selecting the above-described lower limit value and upper limit value.

In the step of bringing the surface 111 into contact with the solution containing the metal ions for a certain period of time or the step of immersing the molded article 110 in the solution containing the metal ions, the contact time or the immersion time is not particularly limited and may be 1 minute or more, 5 minutes or more, and 10 minutes or more, or 1 hour or less, or 45 minutes or less, and 30 minutes or less. The contact time or the immersion time may be a value within a range obtained by arbitrarily selecting the above lower limit value and upper limit value.

### (Other Steps)

The method for manufacturing the molded article according to the present embodiment may include steps other than steps A0, A1 and A2. For example, a washing step and/or a drying step may be included between steps A0 and A1, between steps A1 and A2, and/or after step A2.

### [Method for Manufacturing Fiber-Reinforced Plastic Product]

A method for manufacturing the fiber-reinforced plastic product according to the present embodiment is not particularly limited. For example, the method for manufacturing the fiber-reinforced plastic product according to the present embodiment, which will be described in detail below, can be used.

The method for manufacturing the fiber-reinforced plastic product according to the present embodiment includes (1) a step of applying inositol phosphate to a surface of an outer layer of a fiber-reinforced plastic having the outer layer containing a calcium compound and a resin on at least a part of a surface thereof (hereinafter, referred to as “step B1”), and (2) a step of applying at least one metal ion selected from the group consisting of a silver ion, a zinc ion, and a copper ion to the surface, to which the inositol phosphate is applied, obtained in step B1 (hereinafter, referred to as “step B2”).

Hereinafter, each step will be described. Further, for convenience, a step of manufacturing a fiber-reinforced plastic having an outer layer containing a calcium compound and a resin on at least a part of a surface (hereinafter, referred to as “step B0”) will be described, but the method for manufacturing the fiber-reinforced plastic product according to the present embodiment does not need to include step B0.

### (Step B0)

First, a fiber-reinforced plastic having an outer layer containing a calcium compound and a resin on at least a part of a surface is manufactured. FIG. 6 is a diagram showing the embodiment of step B0. As shown in FIG. 6(A), step B0 may include a step of molding the outer layer 220 is formed on a die 310 for molding a fiber-reinforced plastic product into a desired shape, and further forming the fiber-reinforced plastic layer 210 on the outer layer 220 to manufacture a fiber-reinforced plastic 300 having an outer layer containing a calcium compound and a resin on at least a part of a surface. Alternatively, as shown in FIG. 6(B), step B0 may include a step of forming the fiber-reinforced plastic layer 210 on the die 310, and further forming the outer layer 220 on the fiber-reinforced plastic layer 210 to manufacture a fiber-reinforced plastic 300 having an outer layer containing a calcium compound and a resin on at least a part of a surface.

Step B0 may further include, after the step of manufacturing the fiber-reinforced plastic 300 having the outer layer containing the calcium compound and the resin on at least a part of the surface, a step of forming a new outer layer 220 on the exposed surface of the fiber-reinforced plastic layer 210.

As the method for forming the outer layer 220, for example, a method for applying a solution in which a resin, as necessary, a curing agent, and a calcium compound are mixed at an appropriate mixing ratio, and drying and curing the outer layer 220 may be used. Alternatively, the outer layer 220 may be formed by adding a calcium compound to a solution containing a thermoplastic resin and applying the solution. As the resin and the calcium compound, those described above may be used. It is preferable to adjust the blending amount of the resin and the calcium compound so that the contents of the resin and the calcium compound are within the above-described range.

As a method for forming the fiber-reinforced plastic layer 210, a method known in the related art may be used. For example, the fiber-reinforced plastic layer may be formed by a hand lay-up molding method or a mechanical molding method.

### (Step B1)

Next, inositol phosphate is applied to the surface of the outer layer 220 of the fiber-reinforced plastic obtained in step B0. That is, as shown in FIG. 7, step B1 is a step of applying the inositol phosphate 102 to the surface 221 of the outer layer 220 of the fiber-reinforced plastic 300.

Step B1 may be performed in the same manner as in step A1 except that the target to which inositol phosphate is applied is changed from the surface 111 of the molded article 110 of the resin composition to the surface 221 of the outer layer 220 of the fiber-reinforced plastic 300.

### (Step B2)

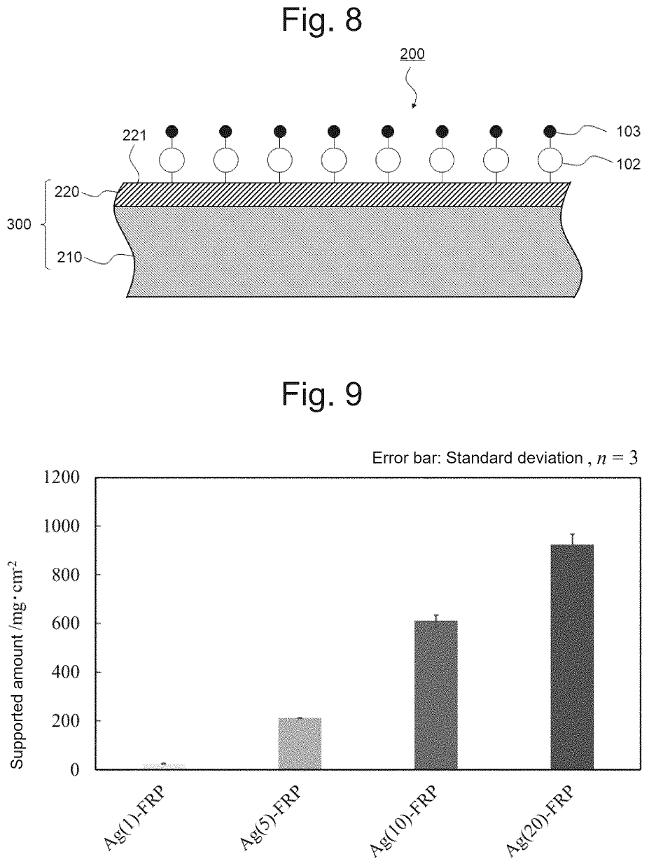

Next, at least one metal ion selected from the group consisting of a silver ion, a zinc ion, and a copper ion is applied to the surface 221 of the outer layer 220 having inositol phosphate obtained in step B1. That is, as shown in FIG. 8, step B2 is a step of applying a predetermined metal element 103 (at least one metal element selected from the group consisting of silver, zinc, and copper) on the surface 221 of the outer layer 220 of the fiber-reinforced plastic 300 having the inositol phosphate 102. The fiber-reinforced plastic product 200 is manufactured in such step B2.

Step B2 may be performed in the same manner as in step A2 except that the target to which the metal ion is applied is changed from the surface 111 of the molded article 110 of the resin composition to the surface 221 of the outer layer 220 of the fiber-reinforced plastic 300.

### (Other Steps)

The method for manufacturing the fiber-reinforced plastic product according to the present embodiment may include steps other than steps B0, B1 and B2, and for example, between steps B0 and B1 and steps B1 and B2 and/or after step B2, a washing step and/or a drying step may be included.

### [Method for Improving or Imparting Antibacterial or Antiviral Properties of Molded Article]

As described above, it is considered that the molded article and the fiber-reinforced plastic product according to the present embodiment have antibacterial or antiviral properties mainly due to the salt of inositol phosphate with metal ions and/or metal ions eluted from the salt. Therefore, it is considered that the molded article and the fiber-reinforced plastic product according to the present embodiment have lowered antibacterial or antiviral properties in a case where the metal ions are eluted after long term use.

Even in such a case, according to a method for improving or imparting the antibacterial or antiviral properties of the molded article according to the present embodiment (hereinafter, simply referred to as a “method for improving or imparting antibacterial or antiviral properties according to the present embodiment”), the antibacterial or antiviral properties of the molded article and the fiber-reinforced plastic product having lowered antibacterial or antiviral properties can be improved.

That is, the method for improving or imparting antibacterial or antiviral properties according to the present embodiment is a method for improving or imparting antibacterial or antiviral properties of a molded article containing a calcium compound and a resin and having inositol phosphate on a surface thereof, and includes a step of applying at least one metal ion selected from the group consisting of a silver ion, a zinc ion, and a copper ion to the surface having the inositol phosphate.

According to the method, excellent antibacterial or antiviral properties can be easily imparted to a molded article which does not have a metal element such as silver, zinc, copper, or the like, or the antibacterial or antiviral properties of a molded article with an insufficient amount of metal element, such as silver, zinc, copper, or the like, supported can be easily improved.

In the method for improving or imparting antibacterial or antiviral properties according to the present embodiment, the target for improving or imparting antibacterial or antiviral properties is a molded article containing a calcium compound and a resin and having inositol phosphate on a surface thereof. The molded article may be a fiber-reinforced plastic or may not be a fiber-reinforced plastic. The surface of the molded article may or may not have at least one metal element selected from the group consisting of silver, zinc, and copper.

In one aspect of the method for improving or imparting antibacterial or antiviral properties according to the present embodiment, the molded article to which the metal ion is applied is the molded article according to the present embodiment that has lost the antibacterial or antiviral properties, that is, an aspect in which the metal atom is eluted from the surface of the molded article according to the present embodiment. According to this aspect, the antibacterial or antiviral properties of the molded article according to the present embodiment that has lost the antibacterial or antiviral properties can be restored.

In one aspect of the method for improving or imparting antibacterial or antiviral properties according to the present embodiment, the molded article to which the metal ion is applied includes a fiber-reinforced plastic layer and an outer layer that is disposed on the fiber-reinforced plastic layer, and the outer layer contains the calcium compound and the resin, and has inositol phosphate on a surface thereof. According to this aspect, it is possible to impart antibacterial or antiviral properties to the fiber-reinforced plastic, or to improve the antibacterial or antiviral properties of the fiber-reinforced plastic.

As the step of applying the metal ion to the surface of the molded article, the same method as in step A2 or B2 in the method for manufacturing the molded article according to the present embodiment described above can be used.

The method for improving or imparting antibacterial or antiviral properties according to the present embodiment may include, before the step of applying the metal ion, a step of applying inositol phosphate to the surface of the molded article as in step A1 or B1 in the method for manufacturing the molded article according to the present embodiment.

### [Addendum]

The present invention includes the following aspects.

[1]

A molded article comprising a calcium compound, and a resin, in which the molded article has a salt of inositol phosphate with at least one metal element selected from the group consisting of silver, zinc, and copper on a surface thereof.

[2]

The molded article according to [1], wherein the inositol phosphate has 3 or more and 6 or less phosphate groups.

[3]

The molded article according to [2], wherein the inositol phosphate is phytic acid.

[4]

The molded article according to any one of [1] to [3], wherein the calcium compound is an inorganic salt of calcium.

[5]

The molded article according to any one of [1] to [4], wherein the molded article has at least any one of antibacterial and antiviral properties.

[6]

The molded article according to any one of [1] to [5], wherein the molded article comprises a fiber-reinforced plastic layer, and an outer layer that is disposed on the fiber-reinforced plastic layer, and the outer layer comprises the calcium compound and the resin, and has the salt of inositol phosphate with at least one metal element selected from the group consisting of silver, zinc, and copper on a surface thereof.

[7]

The molded article according to [6], wherein the average thickness of the outer layer is 0.1 mm or more and 5.0 mm or less.

[8]

The molded article according to any one of [1] to [7], wherein the molded article is a bathtub, a sanitary product, playground equipment, a flower vase, a champagne cooler, a portable toilet box, a washing tub, stationery, an automobile handle, a door knob, a food court tray or table, a station or park bench, or an interior member of a vehicle, an aircraft, or a building.

[9]

An antiviral molded article comprising a calcium compound, and a resin, wherein the molded article has inositol phosphate and at least one metal ion selected from the group consisting of a silver ion, a zinc ion, and a copper ion.

[10]

Use of the molded article according to any one of [1] to [8] for reducing infectious viruses.

[11]

A method for manufacturing a molded article comprising:
a step of applying inositol phosphate to at least a part of a surface of a molded article of a resin composition which comprises a calcium compound and a resin, and
a step of applying at least one metal ion selected from the group consisting of a silver ion, a zinc ion, and a copper ion to the surface having the inositol phosphate.
   [12]

A method for manufacturing a fiber-reinforced plastic product comprising:
a step of applying inositol phosphate to a surface of an outer layer of a fiber-reinforced plastic which comprises the outer layer comprising a calcium compound and a resin on at least a part of a surface thereof, and
a step of applying at least one metal ion selected from the group consisting of a silver ion, a zinc ion, and a copper ion to the surface having the inositol phosphate.
   [13]

The manufacturing method according to or [12], wherein the step of applying the inositol phosphate is a step of bringing the surface to which the inositol phosphate is applied into contact with an aqueous solution comprising inositol phosphate.

[14]

A method for improving or imparting antibacterial or antiviral properties of a molded article comprising a calcium compound and a resin and having inositol phosphate on a surface thereof, the method comprising:
a step of applying at least one metal ion selected from the group consisting of a silver ion, a zinc ion, and a copper ion to the surface having the inositol phosphate
   [15]

The method according to [14], wherein the molded article is a molded article that has lost antibacterial or antiviral properties, and
the method restores the antibacterial or antiviral properties of the molded article.
   [16]

The method according to or [15], wherein the molded article comprises a fiber-reinforced plastic layer, and an outer layer that is disposed on the fiber-reinforced plastic layer, and
the outer layer comprises the calcium compound and the resin and has the inositol phosphate on a surface thereof.

### EXAMPLES

The present invention will hereinafter be described in detail by Examples and Comparative Examples. The present invention is not limited by the following examples.

### [Manufacture of Fiber-Reinforced Plastic]

A fiber-reinforced plastic was manufactured as follows.

First, a fiber-reinforced plastic including a fiber-reinforced plastic layer containing glass fibers and an unsaturated polyester resin, and an outer layer formed on the fiber-reinforced plastic layer and containing calcium carbonate and an unsaturated polyester resin was formed by a hand lay-up molding method. The content of calcium carbonate in the outer layer was 50% by mass with respect to the entire outer layer. In addition, the average thickness of the outer layer obtained by the above method was 0.3 mm. A commercially available calcium carbonate fine particle having a particle diameter of about 2.2 μm was used for the formation of the outer layer. However, when the cross section of the outer layer was observed by SEM, the calcium carbonate fine particles formed an aggregate, and the particle diameter of the aggregate was 15 μm.

Next, by immersing the fiber-reinforced plastic in an aqueous solution of inositol phosphate (phytic acid) having a pH of 7.3 (phytic acid concentration: 1000 mg/dm³) at 37° C. for 24 hours, inositol phosphate was applied to the outer layer of the fiber-reinforced plastic. Then, the fiber-reinforced plastic was washed with pure water. It was confirmed by EDX that inositol phosphate was applied to the outer layer of the fiber-reinforced plastic.

Next, by immersing the fiber-reinforced plastic to which inositol phosphate was applied in a silver nitrate aqueous solution at room temperature for 15 minutes, silver ions were applied to the outer layer of the fiber-reinforced plastic. The concentration of the silver nitrate aqueous solution was 1 mM, 5 mM, 10 mM, or 20 mM, and a plurality of samples having different amounts of silver supported were prepared. This fiber-reinforced plastic was washed with pure water and dried to obtain a fiber-reinforced plastic having inositol phosphate and silver ions.

When the surface of the outer layer of the obtained fiber-reinforced plastic was observed using SEM, an energy-dispersive X-ray analyzer (EDX), and an inductively coupled plasma atomic emission spectrophotometer (ICP-AES), the presence of silver was confirmed at the supported amount depending on the concentration of the silver nitrate aqueous solution used (1 mM, 5 mM, 10 mM, or 20 mM). From the above, it was confirmed that the fiber-reinforced plastic in which silver ions were immobilized on the surface of the outer layer could be manufactured.

FIG. 9 shows a relationship between the concentration of the silver nitrate aqueous solution and the amount of silver supported in the outer layer measured by ICP-AES.

Specifically, regarding the method for measuring the amount of the metal element supported by ICP-AES, the measurement was performed as follows. First, the silver ion concentration of the silver nitrate aqueous solution before the fiber-reinforced plastic was immersed was measured by ICP-AES. Next, after the fiber-reinforced plastic was immersed in the silver nitrate aqueous solution, the supernatant was collected and the silver ion concentration of the aqueous solution was measured again. The amount of the metal element supported was determined by subtracting two times of measurements. In addition, ICP-AES measurement was performed by the calibration curve method. An apparatus used was PS-7800 manufactured by Hitachi High-Technologies Corporation.

### [Evaluation of Antibacterial Properties of Fiber-Reinforced Plastic] (Test Example 1)

The antibacterial properties of the fiber-reinforced plastic obtained above were evaluated in accordance with Japanese Industrial Standards (JIS Z 2801:2010). In addition, as a sample of Example, a fiber-reinforced plastic having silver ions immobilized using a 20 mM silver nitrate aqueous solution in the above manufacturing method was used, and as a control sample (control), a fiber-reinforced plastic to which inositol phosphate and silver ions were not applied was used.

The specific evaluation procedure is as follows.

A bacterial solution containing Escherichia coli (E. coli) precultured in LB medium was prepared at a seeding density of 5×10⁵ CFU/mL. The prepared bacterial solution was seeded on the sample and then covered with a film. The bacterial solution on the sample was cultured at 37° C. for 24 hours and then washed out. The obtained washing solution was diluted, and the diluted washing solution was cultured at 37° C. for 24 to 48 hours on the LB medium, and then the number of colonies was observed. The number of viable bacteria was calculated from the number of colonies appeared.

As a result, while the arithmetic average of the viable bacteria was 11×10⁷ CFU/mL in the control samples to which inositol phosphate and silver ions were not applied (number of samples: 3), the arithmetic average of the viable bacteria was within a range of 0.0×10⁵ CFU/mL to 1.0×10⁵ CFU/mL in the samples of Examples to which inositol phosphate and silver ions were applied (number of samples: 3).

When the antibacterial activity value obtained from the following equation was calculated based on the above results, the antibacterial activity value of the fiber-reinforced plastic in Example was 2.5 or more.

Antibacterial activity value=log (number of viable bacteria after culturing non-antibacterial processed sample)−log (number of viable bacteria after culturing antibacterial processed sample)

The antibacterial activity value is a value that is an index of the superiority or inferiority of the antibacterial properties of the antibacterial material, and in a case where the value is 2.0 or more, it can be determined that the antibacterial material has sufficient antibacterial properties. It was found that the fiber-reinforced plastic of Example had an antibacterial activity value of 2.5 or more and had excellent antibacterial properties.

### Test Example 2

As a sample of Example, a fiber-reinforced plastic having silver ions immobilized using a 1 mM, 5 mM or 10 mM silver nitrate aqueous solution in the above manufacturing method was used, and the antibacterial properties of the fiber-reinforced plastic according to the present embodiment were evaluated in the same manner as in Test Example 1 except that Escherichia coli (E. coli) and Staphylococcus aureus (S. aureus) were used as bacteria.

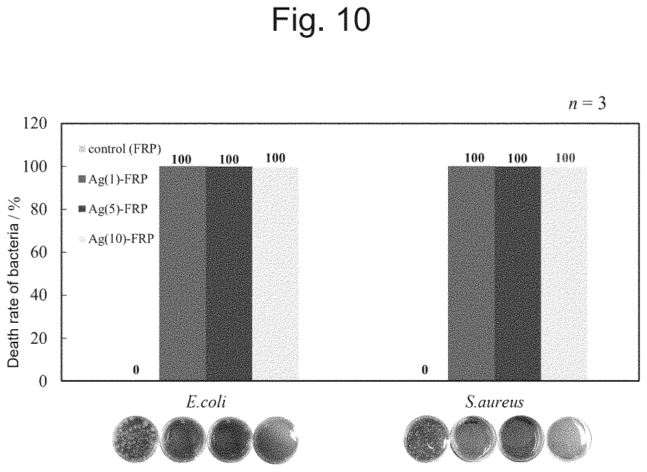

FIG. 10 shows a death rate of bacteria in the control sample (fiber-reinforced plastic to which inositol phosphate and silver ions were not applied) and the samples of each Example. It is found that in any of the samples of Examples, the death rate of the bacteria is 100%, and the antibacterial activity value is 2 or more.

From the above, it was found that the molded article (fiber-reinforced plastic) according to the present embodiment has excellent antibacterial properties.

### [Evaluation of Sustained Release of Metal Ion (Durability of Antibacterial Properties)]

Next, the durability of the antibacterial properties of the above-described fiber-reinforced plastic was investigated.

A fiber-reinforced plastic having silver ions immobilized using a 1 mM, 5 mM, 10 mM, or 20 mM silver nitrate aqueous solution in the above manufacturing method was used as a sample. Each sample was immersed in a HEPES solution (concentration: 20 mM, pH: 7.3, liquid volume: 10 cm³), and subjected to constant temperature shaking at 37.0° C. and a rotation speed of 100 rpm for 1, 3, 5, and 7 days. After completion of the shaking, the supernatant was collected, and the silver ion concentration of the supernatant was measured by ICP-AES.

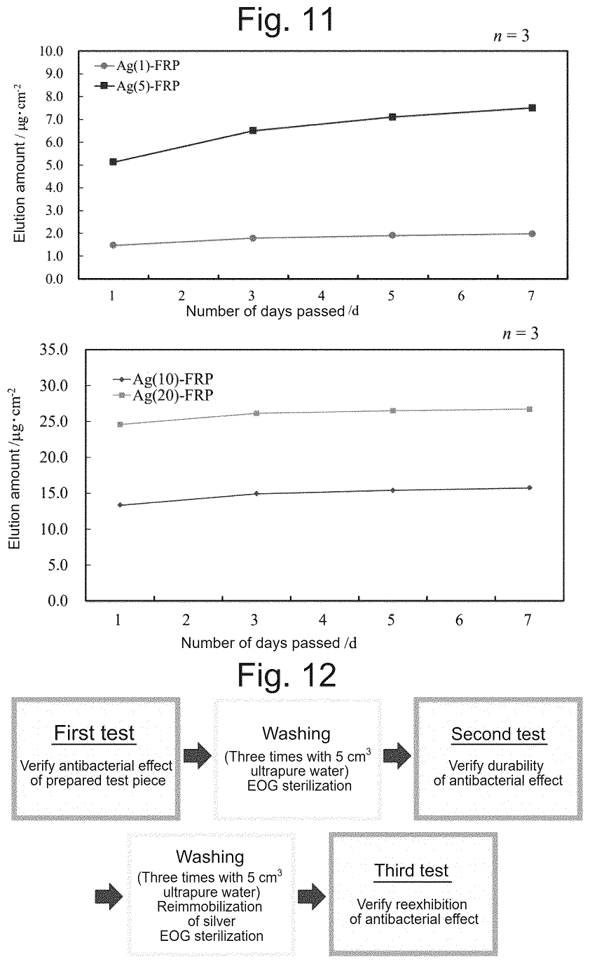

FIG. 11 shows a relationship between the silver ion concentration (elution amount) in the supernatant and the shaking period for each sample. In all the samples, the sustained release of silver ions on the scale of several days was confirmed.

### [Evaluation of Restorability of Antibacterial Properties]

Next, it was confirmed that when the fiber-reinforced plastic described above released metal ions and lost the antibacterial or had lowered antibacterial properties, the antibacterial properties could be imparted again or the antibacterial properties could be improved by applying the metal ions (restorability of antibacterial properties).

A fiber-reinforced plastic (fiber-reinforced plastic) having silver ions immobilized using a 1 mM or 5 mM silver nitrate aqueous solution in the above manufacturing method was used as a sample.

First, for each sample, the death rate of Escherichia coli was measured in the same manner as in (Test Example 2) in [Evaluation of Antibacterial Properties of Fiber-Reinforced Plastic]. This test is referred to as a first test. Next, the sample used in this measurement was washed three times with 5 cm³ of ultrapure water, and sterilized with ethylene oxide gas (EOG), and then the death rate of Escherichia coli was measured again in the same manner as the first test. This test is referred to as a second test. Next, after the sample used in this measurement was washed three times with 5 cm³ of ultrapure water, the sample was immersed in a silver nitrate aqueous solution (silver nitrate concentration: 1 mM or 5 mM, the same concentration used when manufacturing each sample) at room temperature for 15 minutes, and thus silver ions were applied again to the outer layer of the fiber-reinforced plastic. After this sample was sterilized with EOG, the death rate of Escherichia coli was measured again in the same manner as in the first test. This test is referred to as a third test. An outline of the protocol of this test is shown in FIG. 12.

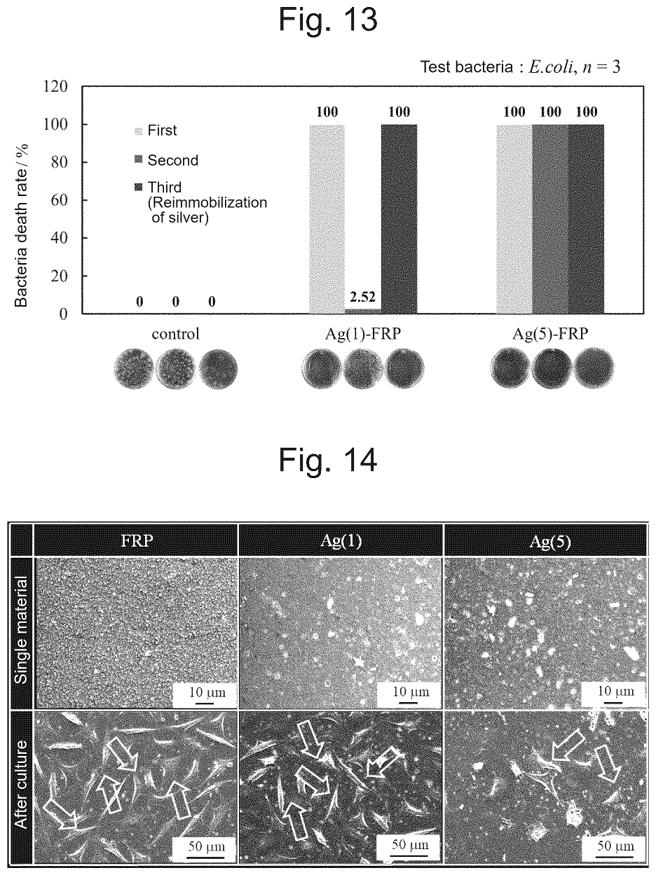

FIG. 13 shows the death rate of Escherichia coli for each sample in the first to third tests.

In the samples prepared using a 1 mM silver nitrate aqueous solution, a significant decrease in the death rate in the second test and a significant increase in the death rate in the third test were confirmed. This suggests that the antibacterial properties of the fiber-reinforced plastic are lowered by the elution of metal ions, and the lowered antibacterial properties can be easily restored by applying the metal ions again.

On the other hand, in the sample prepared using a 5 mM silver nitrate aqueous solution, a significant decrease in the death rate in the second test was not confirmed. This suggests that the durability of the antibacterial properties of the fiber-reinforced plastic can be controlled by adjusting the metal ion concentration in the solution containing the metal ions used during preparation.

### [Evaluation of Antibacterial Cytotoxicity]

Next, the cytotoxicity of the fiber-reinforced plastic was evaluated.

The evaluated cells were mouse connective tissue-derived fibroblasts (L929 cells) (passage number: p=3˜), and the culture medium used was Eagle's minimum essential medium supplemented with 10% fetal bovine serum, 100 U/cm³ penicillin, and 100 μg/cm³ streptomycin. The cell culture environment was set at a temperature of 37° C. under an atmosphere of 5% CO₂.

### (SEM Observation)

A fiber-reinforced plastic (fiber-reinforced plastic) having silver ions immobilized using a 1 mM or 5 mM silver nitrate aqueous solution in the above manufacturing method was used as a sample. In addition, a fiber-reinforced plastic which was not surface-treated with inositol phosphate and silver nitrate was used as a control sample.

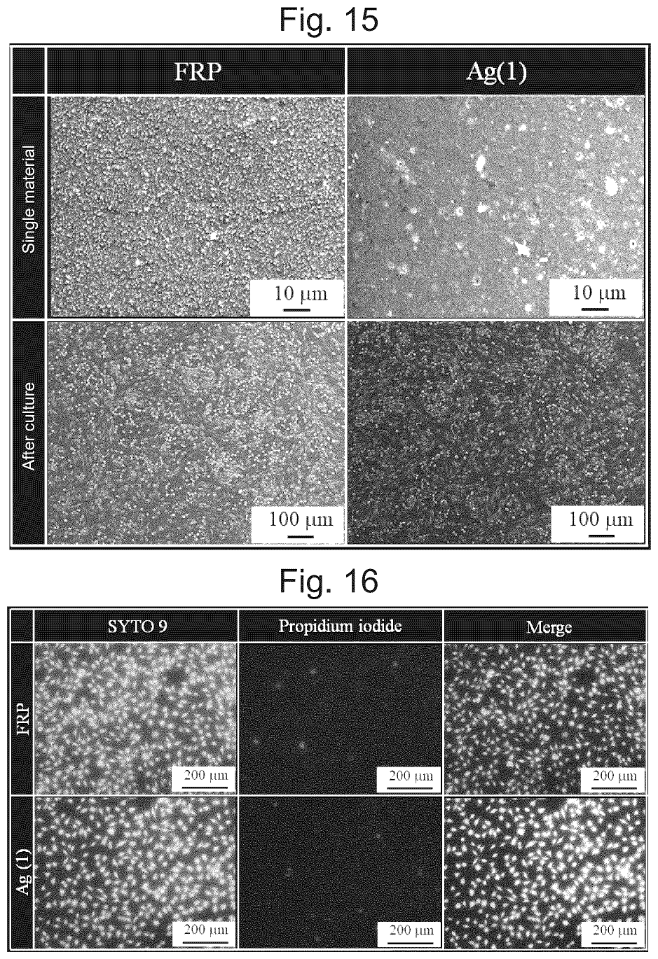

The cultured L929 cells were seeded on the above samples. The seeding density was 6.0×10⁴ cells/cm³. One day after culture, each sample was immersed in 10 vol % glutaraldehyde at 4° C. for 1 hour or more, and washed with a phosphate buffered saline. Further, each sample was washed with sterilized water, then frozen with liquid nitrogen, and freeze-dried for one night or more. The obtained sample was observed by SEM. The observation images of each sample are shown in FIG. 14. As shown in FIG. 14, cells were confirmed in all of the samples. This means that the cells were successfully cultured on all of the samples.

In order to confirm that the growth of the cells was not inhibited even after the cells were cultured for one day or more, a fiber-reinforced plastic having silver ions immobilized using a 1 mM silver nitrate aqueous solution was used, and an untreated fiber-reinforced plastic as a control sample was used, and the same SEM observation was also performed four days after the culture. The observation images of each sample are shown in FIG. 15. Also in the sample of Example, a large number of extending cells were confirmed in the same manner as in the control sample.

### (Live/Dead Staining)

A fiber-reinforced plastic having silver ions immobilized using a 1 mM silver nitrate aqueous solution in the above manufacturing method was used as a sample. In addition, a fiber-reinforced plastic which was not surface-treated with inositol phosphate and silver nitrate was used as a control sample.

The cultured L929 cells were seeded on the above samples. The seeding density was 6.0×10⁴ cells/cm³. One day or four days after the culture, the cells were stained with SYTO9 and Propidium iodide. A LIVE/DEAD (registered trademark) BacLight Bacterial Viability Kit (L7012) was used for staining. After staining the cells, the cells were shielded from light for 15 minutes and observed using a microscope. Note that SYTO9 stains all cells, and Propidium iodide stains only cells with damaged membranes. Therefore, according to this method, living cells and dead cells can be observed.

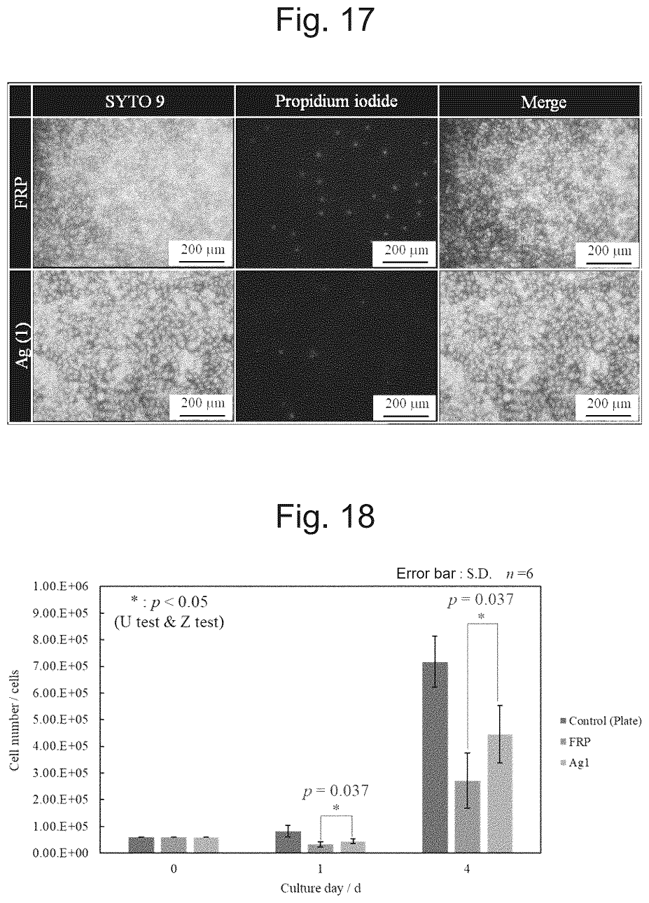

The observation images of each sample are shown in FIGS. 16 and 17. FIGS. 16 and 17 correspond to the observation images on the first day and fourth day after culture, respectively. As shown in FIGS. 16 and 17, a large number of living cells were confirmed in the sample of Example as well as in the control sample.

### (Measurement of Relative Cell Growth Ratio)

A fiber-reinforced plastic having silver ions immobilized using a 1 mM silver nitrate aqueous solution in the above manufacturing method was used as a sample. In addition, a fiber-reinforced plastic which was not surface-treated with inositol phosphate and silver nitrate and a cell culture plate were used as control samples.

The cultured L929 cells were seeded on the above samples. The seeding density was 6.0×10⁴ cells/cm³. One day or four days after culture, the cell number in each sample was measured using an Automated Cell Counter (TC20) manufactured by Bio-Rad Laboratories, Inc.

For each sample, FIG. 18 shows the measurement results of the cell number at the start of culture, on the first day after culture, on the fourth day after culture. According to FIG. 18, it was suggested that although the fiber-reinforced plastic having silver ions immobilized using a 1 mM silver nitrate aqueous solution was inferior to the cell culture plate, the fiber-reinforced plastic had a better cell culture environment compared with the untreated fiber-reinforced plastic. That is, it was suggested that the fiber-reinforced plastic having silver ions immobilized using a 1 mM silver nitrate aqueous solution had lower cytotoxicity than the untreated fiber-reinforced plastic.

Based on the data shown in FIG. 18, the relative cell growth ratio M was calculated from the following equation.

$$M = \frac{log \text{?} - log \text{?}}{log \text{?} - log \text{?}}$$

$${N}_{4} : Cell number in sample on fourth day$$

$${N}_{1} : Cell number in sample on first day$$

$${{N}_{4}}^{control} : Cell number in Control on fourth day$$

$${{N}_{1}}^{control} : Cell number in Control on first day$$

$$\text{?} \text{indicates text missing or illegible when filed}$$

The relative values of the relative cell growth ratio in the cell culture plate (Control), the relative cell growth ratio in the untreated fiber-reinforced plastic (FRP), and the relative cell growth ratio in the fiber-reinforced plastic having silver ions immobilized using a 1 mM silver nitrate aqueous solution (Ag(1)) are shown in Table 1. In Table 1, each value is relatively shown with the relative cell growth ratio of Control or FRP as 100.

TABLE 1

| | Control | FRP | Ag(1) |
|---|---|---|---|
| Control based | (100.0) | 97.8 | 106.8 |
| FRP based | 102.3 | (100.0) | 109.2 |

The fiber-reinforced plastic of Example had a relative cell growth ratio of 109.2% based on the untreated fiber-reinforced plastic. Since the relative cell growth ratio was 70% or more, it was determined that the fiber-reinforced plastic of Example was not cytotoxic according to “Determination criteria for colony formation method using extraction method” of “Basic Principles for Biological Safety Evaluation Required for Application for Approval to Market Medical Devices—Part 1: Cytotoxicity Test, Notification No. 0301-20 issued by Pharmaceutical and Food Safety Bureau, Medical Device Evaluation Office, on Mar. 1, 2012”.

### [Evaluation of Antiviral Properties of Fiber-Reinforced Plastic]

The antiviral properties of the fiber-reinforced plastic obtained were evaluated in accordance with an International Standard (ISO 21702). As a sample of Example, a fiber-reinforced plastic having silver ions immobilized using a 1 mM or 5 mM silver nitrate aqueous solution in the above manufacturing method was used, and as a control sample, a fiber-reinforced plastic to which inositol phosphate and silver ions were not applied was used. Each sample was sterilized with EOG before the test, and the number of samples was set to 3.

In addition, as the test virus, feline calicivirus was used and as host cells, CRFK cells were used.

The specific evaluation procedure is as follows.

A virus solution prepared to have an infectivity titer of 2.3×10⁶ PFU/cm³ was seeded on each sample and left to stand at 25.0° C. for 24 hours. Then, the virus solution on the sample was washed out and seeded on the precultured host cells. Then, the cells were cultured for a predetermined period of time and fixed in a semi-solid medium. The medium was stained with crystal violet and the number of plaques was counted. The logarithm value of the infectivity titer per unit area was calculated from the number of plaques.

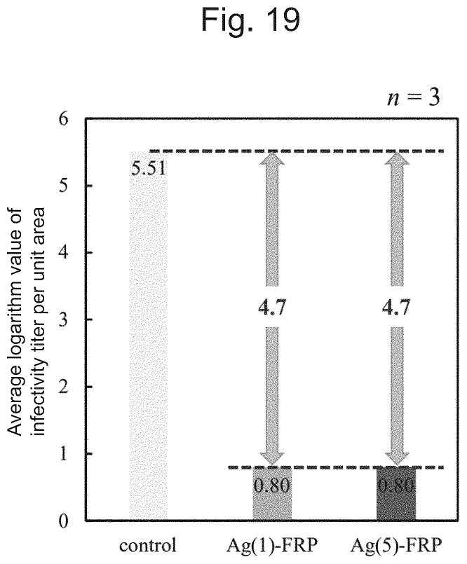

The average logarithm value of the infectivity titer per unit area of each sample is shown in FIG. 19.

From the data shown in FIG. 19, it was found that the antiviral activity value calculated from the following equation in the fiber-reinforced plastic having silver ions immobilized using a 1 mM or 5 mM silver nitrate aqueous solution was 4.7.

Antiviral activity value=log (virus infectivity titer per unit area after culturing non-antiviral processed sample)−log (virus infectivity titer per unit area after culturing antiviral processed sample)

According to the Japanese Industrial Standards (JIS L 1922:2016, Annex G), when the antiviral activity value is 2 or more and less than 3, “there is an antiviral effect”, and when the antiviral activity value is 3 or more, “there is a sufficient antiviral effect”. Therefore, it was found that the fiber-reinforced plastic of Example had excellent antiviral properties.

### INDUSTRIAL APPLICABILITY

The present invention can provide a member and a product having excellent antibacterial or antiviral properties and mechanical properties, and has industrial applicability, for example, in the field of improving public health and the like.

### REFERENCE SIGNS LIST

100, 110 . . . molded article
101, 111, 221 . . . surface
102 . . . inositol phosphate
103 . . . metal element
104 . . . calcium compound
200 . . . fiber-reinforced plastic product
210 . . . fiber-reinforced plastic layer
220 . . . outer layer
300 . . . fiber-reinforced plastic
310 . . . die

1. A molded article comprising:
a calcium compound; and
a resin,
wherein the molded article has a salt of inositol phosphate with at least one metal element selected from the group consisting of silver, zinc, and copper on a surface thereof.

2. The molded article according to claim 1, wherein the inositol phosphate has 3 or more and 6 or less phosphate groups.

3. The molded article according to claim 2, wherein the inositol phosphate is phytic acid.

4. The molded article according to claim 1, wherein the calcium compound is an inorganic salt of calcium.

5. The molded article according to claim 1, wherein the molded article has at least any one of antibacterial and antiviral properties.

6. The molded article according to claim 1, wherein the molded article comprises a fiber-reinforced plastic layer, and an outer layer that is disposed on the fiber-reinforced plastic layer, and the outer layer comprises the calcium compound and the resin, and has the salt of inositol phosphate with at least one metal element selected from the group consisting of silver, zinc, and copper on a surface thereof.

7. The molded article according to claim 6, wherein the average thickness of the outer layer is 0.1 mm or more and 5.0 mm or less.

8. The molded article according to claim 1, wherein the molded article is a bathtub, a sanitary product, playground equipment, a flower vase, a champagne cooler, a portable toilet box, a washing tub, stationery, an automobile handle, a door knob, a food court tray or table, a station or park bench, or an interior member of a vehicle, an aircraft, or a building.

9. A method for manufacturing a molded article comprising:
a step of applying inositol phosphate to at least a part of a surface of a molded article of a resin composition comprising a calcium compound and a resin; and
a step of applying at least one metal ion selected from the group consisting of a silver ion, a zinc ion, and a copper ion to the surface to which the inositol phosphate is applied.

10. A method for manufacturing a fiber-reinforced plastic product comprising:
a step of applying inositol phosphate to a surface of an outer layer of a fiber-reinforced plastic which comprises the outer layer comprising a calcium compound and a resin on at least a part of a surface thereof; and
a step of applying at least one metal ion selected from the group consisting of a silver ion, a zinc ion, and a copper ion to the surface to which the inositol phosphate is applied.

11. The manufacturing method according to claim 9, wherein the step of applying the inositol phosphate is a step of bringing the surface to which the inositol phosphate is applied into contact with an aqueous solution comprising inositol phosphate.

12. A method for improving or imparting antibacterial or antiviral properties of a molded article comprising a calcium compound and a resin and having inositol phosphate on a surface thereof, the method comprising:
a step of applying at least one metal ion selected from the group consisting of a silver ion, a zinc ion, and a copper ion to the surface having the inositol phosphate.

13. The method according to claim 12, wherein the molded article is a molded article that has lost antibacterial or antiviral properties, and
the method restores the antibacterial or antiviral properties of the molded article.

14. The method according to claim 12, wherein the molded article comprises a fiber-reinforced plastic layer, and an outer layer that is disposed on the fiber-reinforced plastic layer, and
the outer layer comprises the calcium compound and the resin, and has the inositol phosphate on a surface thereof.

15. The molded article according to claim 6, wherein the inositol phosphate has 3 or more and 6 or less phosphate groups.

16. The molded article according to claim 15, wherein the inositol phosphate is phytic acid.

17. The molded article according to claim 6, wherein the calcium compound is an inorganic salt of calcium.

18. The molded article according to claim 6, wherein the molded article has at least any one of antibacterial and antiviral properties.

19. The molded article according to claim 6, wherein the molded article is a bathtub, a sanitary product, playground equipment, a flower vase, a champagne cooler, a portable toilet box, a washing tub, stationery, an automobile handle, a door knob, a food court tray or table, a station or park bench, or an interior member of a vehicle, an aircraft, or a building.

20. The manufacturing method according to claim 10, wherein the step of applying the inositol phosphate is a step of bringing the surface to which the inositol phosphate is applied into contact with an aqueous solution comprising inositol phosphate.
